(19) United States
(12) Patent Application Publication
(10) Pub. No.: US 2025/0051058 A1
(43) Pub. Date: Feb. 13, 2025

(54) TOOL CONTAINER

(71) Applicant: MILWAUKEE ELECTRIC TOOL CORPORATION, Brookfield, WI (US)

(72) Inventors: Courtney J. Burns, Wauwatosa, WI (US); Tresha A. Nielsen, Waterford, WI (US); David Hlavac, Colgate, WI (US)

(21) Appl. No.: 18/719,674

(22) PCT Filed: Dec. 19, 2022
(86) PCT No.: PCT/US2022/053315

§ 371 Date: Jun. 13, 2024

Related U.S. Application Data
(60) Provisional application No. 63/290,846, filed on Dec. 17, 2021.

(51) Int. Cl. B65D 25/10; B25H 3/00; B25H 3/02; B65D 43/16

(52) U.S. Cl. CPC B65D 25/106; B25H 3/006; B25H 3/02; B65D 43/163; B65D 2543/00194; B65D 2543/00361

(57) ABSTRACT

A container includes a base with base walls and a cavity defined by the base walls, a receptacle on one of the base walls, and a retainer selectively coupled to the receptacle. The retainer is configured to support a plurality of tools within the cavity. The base is sized to receive only a single retainer.

### CROSS-REFERENCE TO RELATED APPLICATION

This application claims priority to U.S. Provisional Patent Application No. 63/290,846 filed Dec. 17, 2021, the entire contents of which are incorporated herein by reference.

### FIELD

The present disclosure relates to a tool container or case, and more specifically, to a tool container or case with modular components allowing for user customization.

### BACKGROUND

Generally, oscillating multi tool (OMT) accessories and blades are stored within a container or case. Such containers/cases may include retainers or holders for supporting tools, accessories, and/or blades within the container/case to inhibit the tools, accessories, and/or blades from moving within the container/case.

### SUMMARY

In one aspect, the invention provides a container including a base with base walls and a cavity defined by the base walls, a receptacle on one of the base walls, and a retainer selectively coupled to the receptacle. The retainer is configured to support a plurality of tools within the cavity. The base is sized to receive only a single retainer.

In another aspect, the invention provides a container including a base with base walls and a cavity defined by the base walls, a receptacle on one of the base walls, and a retainer selectively received by the receptacle via a snap-fit connection. The retainer is configured to support a stack of oscillating multi tool blades.

In another aspect, the invention provides a retainer configured to be secured within a container. The retainer includes a base portion, an elongated body extending from the base portion, and an insert portion extending from the base portion and including a plurality of tabs. The elongated body is configured to receive a stack of oscillating multi tool blades. The plurality of tabs is configured to extend through a wall of the container and form a snap-fit connection with the retainer. Each tab has a stop extending normally from an end of the tab. The stops are configured to bear against an outer surface of the wall of the container.

Other aspects of the disclosure will become apparent by consideration of the detailed description and accompanying drawings.

### BRIEF DESCRIPTION OF THE DRAWINGS

FIG. 1 is a perspective view of a tool container, illustrating a tool retainer positioned within the tool container and supporting a plurality of tools or workpieces, according to an embodiment of the present disclosure.

FIG. 2 is an exploded view of the tool container of FIG. 1.

FIG. 3 is a cross-sectional view of the tool container of FIG. 1, taken through line 3-3 in FIG. 1.

FIG. 4 is a cross-sectional view of the tool container of FIG. 1, taken through line 4-4 in FIG. 1.

FIG. 5 is an isolated view of the tool retainer of FIG. 1.

FIG. 6A is a cross-sectional view of a tool container and tool retainer, according to another embodiment of the present disclosure.

FIG. 6B is an enlarged perspective of the callout box in FIG. 6A.

FIG. 7 is an isolated view of the tool retainer of FIG. 6A.

### DETAILED DESCRIPTION

Before any embodiments of the disclosure are explained in detail, it is to be understood that the disclosure is not limited in its application to the details of construction and the arrangement of components set forth in the following description or illustrated in the following drawings. The disclosure is capable of other embodiments and of being practiced or of being carried out in various ways. Also, it is to be understood that the phraseology and terminology used herein is for the purpose of description and should not be regarded as limiting. Use of “including” and “comprising” and variations thereof as used herein is meant to encompass the items listed thereafter and equivalents thereof as well as additional items. Use of “consisting of” and variations thereof as used herein is meant to encompass only the items listed thereafter and equivalents thereof. Unless specified or limited otherwise, the terms “mounted,” “connected,” “supported,” and “coupled” and variations thereof are used broadly and encompass both direct and indirect mountings, connections, supports, and couplings.

In general, the present disclosure relates to a container or case 10 for storing tools, such as tool bits, accessories, blades, workpieces, and/or the like. A tool retainer 12 couples to the case 10 and allows a user to store a plurality of tools within the case 10. The illustrated case 10 may be optimized and/or compact to receive a single tool retainer 12, thereby reducing the size or perimeter of the case 10.

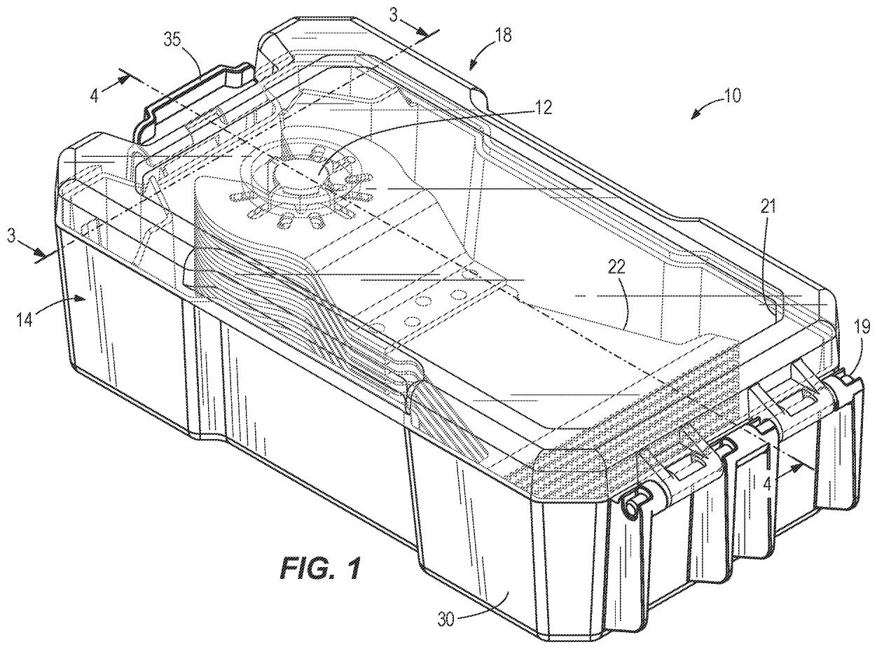

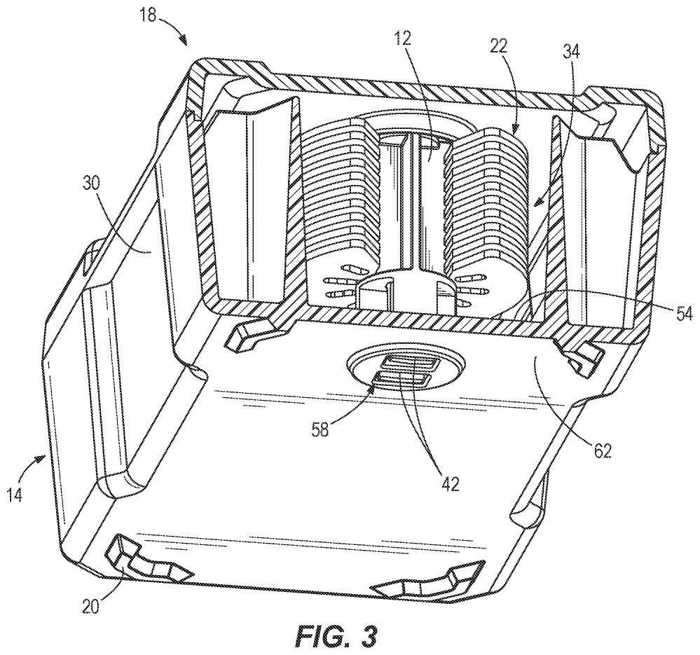

As shown in FIGS. 1-3, the tool container or case 10 includes a base 14 coupled to a lid 18 by a hinge 19. In some instances, the lid 18 and/or base 14 are configured to receive decals and or merchandising/product information. The case 10 may share a complementary interface that accommodates stacking with multiple other cases 10. In the illustrated embodiment, the case 10 includes feet 20 on the base 14 that can be received by a depressed or offset surface 21 on the lid 18 when cases 10 are stacked together. The case 10 may also be stored within other, larger tool cases. The feet 20 may help stabilize the case 10 on a surface or while stacked. As illustrated in FIG. 3, the feet 20 extend away from the base 14 and have a trapezoidal profile. The feet 20 are positioned on corners of the base 14 to provide a rectangular perimeter such that the feet 20 can match a shape or perimeter of the depressed surface 21 on the lid 18. When cases 10 are stacked, the feet 20 of one case 10 engage the depressed surface 21 of another case 10 to inhibit movement of the cases 10 in a horizontal plane.

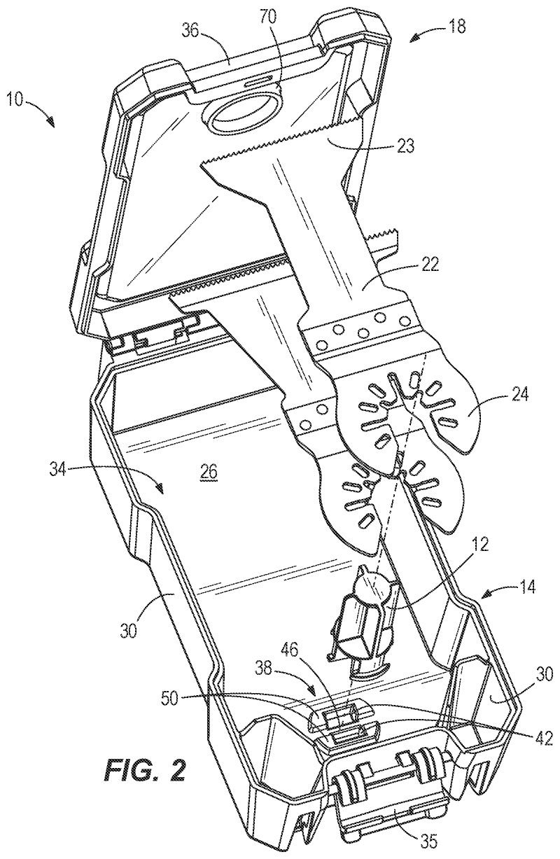

In general, the case 10 is used for storing workpieces or tools. In the illustrated embodiment, the tools are embodied as oscillating multi tool (OMT) blades and accessories 22 (FIGS. 1 and 2). In other embodiments, the tools may be different accessories, such as hole saws, reciprocating saw blades, and other types of saw blades. Typically, OMT blades 22 include a first portion 23 (i.e., teeth or cutting edge) and a second portion 24 (i.e., an anchor) for engaging and/or accommodating mounting to an OMT. The second portion 24 may be offset from or planar with the first portion 23. In the illustrated embodiment, the tool retainer 12 is shaped to accommodate (e.g., receive, mesh with, complement, etc.) the second portion 24 of an OMT blade 22. The tool retainer 12, as illustrated in FIG. 2, may be elongated and cylindrical in shape, and may also be referred to as a peg or pin.

Referring now to FIGS. 2-4, the base 14 includes a first or lower wall 26 and side walls 30 extending from the lower wall 26. The lower wall 26 and the side walls 30 define a cavity 34. The base 14 further includes a latch 35 disposed on one wall 30, and the lid 18 includes a latch receiving portion 36. In some embodiments, the latch 35 may be disposed on the lid 18, and the latch receiving portion 36 may be formed on the base 14. The latch 35 is movable (e.g., slidable, pivotable, detachable, etc.) relative to the wall 30 and selectively engaged with the latch receiving portion 36 to retain the lid 18 to the base 14 in a closed position (FIG. 1), thereby enclosing the cavity 34. When the latch 35 is disengaged from the latch receiving portion 36, the lid 18 may be pivoted about the hinge 19 into an open position. In the illustrated embodiment, the latch 35 and the hinge 19 are located on opposing, relatively shorter side walls 30 of the base 14. As such, the lid 18 opens along a short end of the base 14. In other embodiments, the latch 35 and the hinge 19 may be located on opposing, relatively longer side walls 30 of the base 14.

A pin receptacle/receiving region 38 is provided in the case 10 to support the retainer 12 in the cavity 34. In the illustrated embodiment, the receptacle 38 includes two offset openings or apertures 42. In the illustrated embodiment, the apertures 42 are formed directly on and extend through the lower wall 26 of base 14. As further illustrated in FIGS. 2 and 3, the receptacle 38 receives a single retainer 12. The case 10 of the illustrated embodiment is sized and shaped to include only a single receptacle 38 such that the case 10 is configured to house only a single retainer 12.

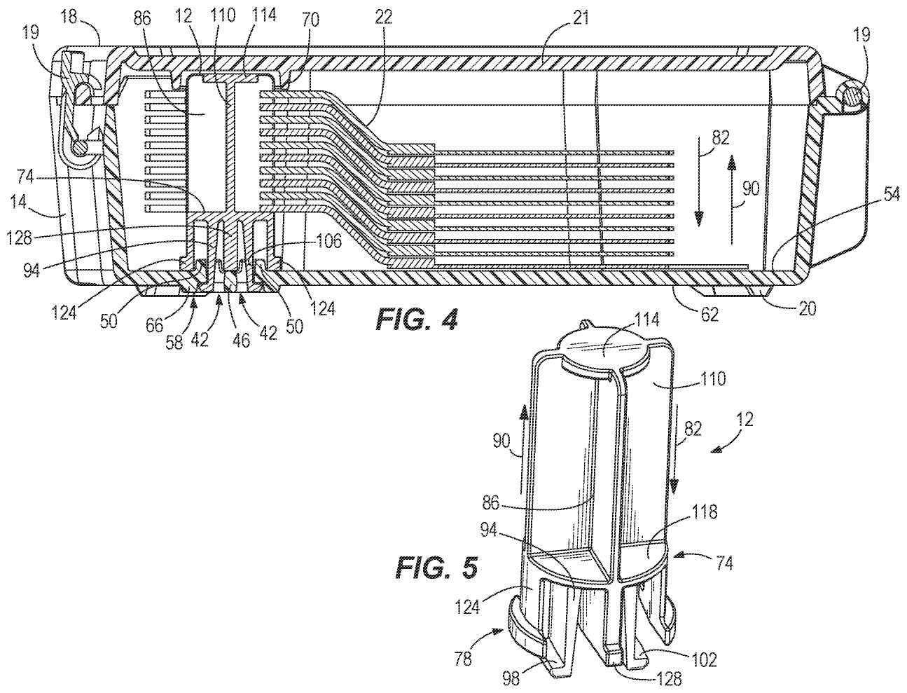

With specific reference to FIGS. 2 and 4, the apertures 42 may be separated by a partition or bridge 46 on one side and at least partially surrounded by a boss 50 on another side. The bridge 46 and the boss 50 may be referred to as locating features. In the illustrated embodiment, the bridge 46 (see also FIG. 4) delimits the two apertures 42 to form two distinct apertures 42. As further illustrated in FIG. 4, the boss 50 is formed on an inner surface 54 of the base 14 (e.g., on top of the lower wall 26 or within the cavity 34). In some embodiments, a pocket 58 is formed on an outer or bottom surface 62 of the base 14 (e.g., on a bottom of the lower wall 26 and outside the cavity 34). The pocket 58 may include a wall 66, such as a cylindrical wall, that extends away from the bottom surface 62 to house a portion of the retainer 12. In a similar manner, as illustrated in FIGS. 2-4, the lid 18 may include a pocket 70, such as a bowl or cup, that is sized and shaped to receive an upper end of the retainer 12 when the lid 18 is closed. The pocket 70 (e.g., on the lid 18) and the receptacle 38 (e.g., on the base 14) can retain the retainer 12 therebetween while the lid 18 is closed.

Referring now to FIGS. 4 and 5, while the lid 18 and base 14 can engage the retainer 12 together while the lid 18 is closed, the receptacle 38 accommodates mounting of the retainer 12, and thereby OMT blades 22, even while the lid 18 is in the open position (FIG. 2). Shown in FIG. 5, the retainer 12 includes a base portion 74, an insert portion 78 extending from the base portion 74 in a downward direction 82, and an elongated body or main body portion 86 extending from the base portion 74 in an upward direction 90. In the illustrated embodiment, the base portion 74, the insert portion 78, and the main body portion 86 are integrally formed as a single piece such that the retainer 12 is a monolithic body. For example, the retainer 12 may be molded or formed from a single piece of plastic. In other embodiments, the base portion 74, the insert portion 78, and/or the main body portion 86 may be separate pieces that are coupled together.

The insert portion 78 includes a plurality of tabs 94 that are outwardly biased relative one another (e.g., biased away from). In the illustrated embodiment, the insert portion 78 includes two tabs 94. In other embodiments, the insert potion 78 may include fewer or more tabs 94. The tabs 94 may be separated by an amount that corresponds to the position of the apertures 42 such that the tabs 94 can extend through the apertures 42. The tabs 94 each include a stop or catch 98 extending normally from ends of the tabs 94. Ends of the tabs 94 may further include ramped faces 102 configured for sliding engagement with an inner face 106 of each of the apertures 42. As the tabs 94 pass into the apertures 42, the ramped faces 102 engage the inner faces 106 of the apertures 42 to bring the tabs 94 closer together. Once the ramped faces 102 clear the apertures 42 and enter into the pocket 58, the tabs 94 snap away from one another, and the stops 98 engage the bottom/outer surface 62. The wall 66 of the pocket 58 may surround the parts of the tabs 94 extending below the bottom surface 62 such that the tabs 94 themselves do not contact a surface (e.g., tabletop, another case, etc.) upon which the case 10 is set. More simply, the retainer 12 may be supported by the base 14 via a snap-fit connection.

For example, during assembly or manufacture of the case 10, the base 14, lid 18, hinge 19, and/or retainer 12 may all be formed as separate bodies, pieces, and/or the like. A user (e.g., assembler) may assemble the base 14 and lid 18 to the hinge 19 and then, in a separate step, snap the retainer 12 into the receptacle 38. In some embodiments, the retainer 12 may be selectively removably coupled to the base 14 such that a user could remove and reattach the retainer 12, or a variety of other retainers/pins, based on a preference of the user (e.g., size of tool, condition of pin, etc.). In other embodiments, the retainer 12 may be permanently attached to the base 14 after assembly by, for example, ultrasonic welding or adhesives.

As illustrated in FIGS. 4 and 5 and discussed above, the main body portion 86 is elongated and generally cylindrical. The main body portion 86 includes ridges 110 that extend along the elongated body 86 between a circular top 114 and the base portion 74. In the illustrated embodiment, four ridges 110 extend along the main body portion 86. The four ridges 110 are equally spaced about the main body portion 86 and are shaped to receive the tool mounting portion 24 of common OMT blades and accessories 22. In other embodiments, the main body portion 86 may include fewer than four ridges 110. The circular top 114 blends into the ridges 110 to help guide OMT blades/accessories 22 onto the main body portion 86. The circular top 114 and the ridges 110 also help reinforce the retainer 12. As illustrated in FIG. 4, the circular top 114 also fits within the pocket 70 of the lid 18 when the lid 18 is closed.

As illustrated in FIG. 4, the main body portion 86 of the retainer 12 is elongated to fit multiple OMT blades/accessories 22 that are stacked or placed on top of one another. In the illustrated embodiment, the main body portion 86 is sized to receive up to ten OMT blades/accessories 22. In other embodiments, the main body portion 86 is sized to receive fewer or more OMT blades/accessories 22.

The main body portion 86 is also sized to inhibit OMT blades/accessories 22 from sliding off of the retainer 12 when the retainer 12 is supported within the case 10 and the lid 18 is closed. More particularly, an overall length of the retainer 12 is generally the same as (or only slightly less than) a distance between the lower surface 26 and an inner surface of the lid 18. As stated above, when the lid 18 is closed, the circular top 114 of the retainer 12 contacts (or is close to) the inner surface of the lid 18 (e.g., in the pocket 70) such that an OMT blade/accessory 22 cannot slide off the top of the retainer 12. The circular top 114 may also help support the lid 18.

As further illustrated in FIG. 5, the main body portion 86 also includes one or more projections 118 positioned between the ridges 110 that form a resting surface or mount for the OMT blades/accessories 22. The illustrated projections 118 are generally semi-circular and planar and extend radially outward from the main body portion 86. The projections 118 help support the second portions 24 (i.e., anchors) of the OMT blades/accessories 22 above the inner surface 54 of the base 14, particularly, when the OMT blades/accessories 22 are offset blades/accessories (as illustrated). In other embodiments, the projections 118 may have different configurations or may be omitted such that the second portions 24 of the OMT blades/accessories 22 slide all the way down the retainer 12 toward the inner surface 54.

With continued reference to FIGS. 4 and 5, the retainer 12 further includes a set of legs 124 and a stand 128, each extending from the base portion 74 in the downward direction 82. In the illustrated embodiment, the stand 128 is generally central on the retainer 12 between the tabs 94 and aligned with at least one of the ridges 110. The stand 128 is sized to bear against the bridge 46 positioned between the apertures 42 when the retainer 12 is snap-fitted in the receptacle 38. Similarly, the legs 124, which may be positioned radially outwardly of the tabs 94, also bear against the lower surface 26 (e.g., the inner surface 54) of the base 14 to constrain the retainer 12. Stated another way, the stops 98 provide an upward force (e.g., in the upward direction 90) against the base 14, while the legs 124 and stand 128 provide an opposing downward force (e.g., in the downward direction 82), thereby constraining the retainer 12 against relative upward-downward movement relative the base 14. The outward bias provided by the tabs 94 against the base 14 inhibits the retainer 12 from being lifted out of the cavity 34 (e.g., when the lid 18 is not closed).

In the illustrated embodiment, the legs 124 may be semi-circular and include an L-shaped tip. Similarly, the stand 128 may have an L-shape extension or tip. With brief reference back to FIG. 4, the stand 128 may abut the bridge 46 between the apertures 42, and the legs 124 may surround the boss 50 such that a substantial amount of the receptacle 38 is surrounded or covered by the retainer 12. In this manner, the retainer 12 may be secured via snap-fit to the base 14, and the OMT blades 22 may slide over the retainer 12 to retain a stack of or a singular OMT blade 22 within the cavity 34.

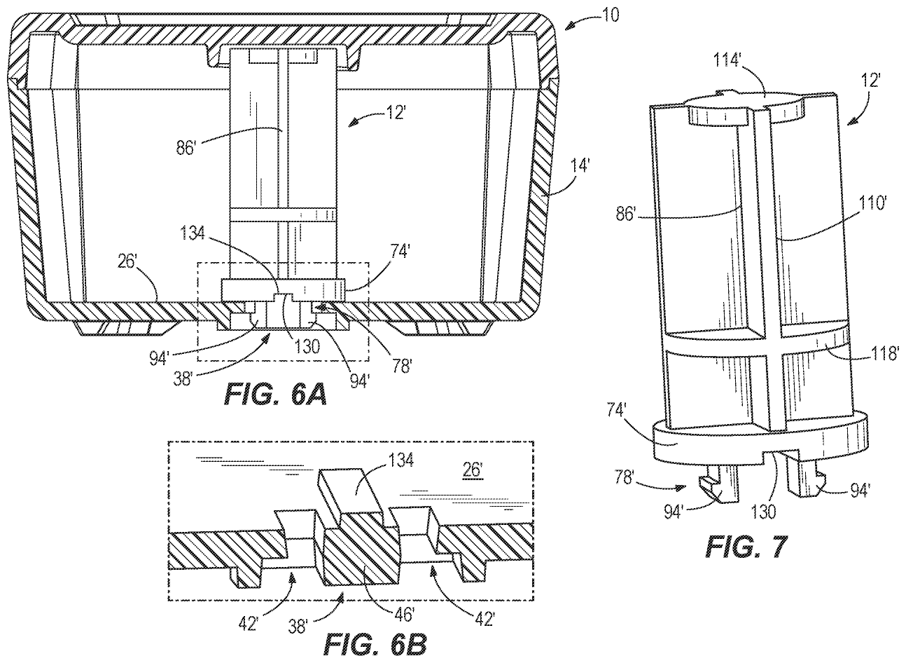

As illustrated in FIGS. 6A, 6B, and 7, the case 10 may include an alternate base 14′ with an alternate receptacle 38′ configured to receive an alternate retainer 12′. In general, the features identified with an apostrophe can be alternately provided with respect to the embodiments disclosed in the present disclosure. For example, it should be understood that the base 14 and alternate base 14′ share features and functionality except for at least the difference described herein.

With reference to FIGS. 6A and 6B, the base 14′ may include the receptacle 38′ configured to receive the retainer 12′ via a snap-fit connection. The receptacle 38′ may include two offset apertures 42′ separated by a partition or bridge 46′. The retainer 12′ includes a base portion 74′, an insert portion 78′ extending from the base portion 74′ in the downward direction 82, and an elongated main body portion 86′ extending from the base portion 74′ in the upward direction 90. The insert portion 78′ of the retainer 12′ interfaces with the receptacle 38′ through connection between outwardly biased tabs 94′ and a bottom/outer surface of the base 14′. In contrast to the retainer 12, the base portion 74′ and the insert portion 78′ of the retainer 12′ both bear directly against a lower surface 26′ of the base 14′. In the illustrated embodiment of FIGS. 6A-7, the base portion 74′ further includes a slot or channel 130 that abuts a prong or bar 134 extending upwardly from the bridge 46″. In this manner, the base portion 74′ of the retainer 12′ may function like the legs 124 and the stand 128 of the retainer 12 to stabilize the retainer 12′ when snap-fitted to the base 14′. It should be further understood that the retainer 12′, like the retainer 12, includes ridges 110′, lands or projections 118′, and a circular top 114′ that are shaped to receive and support the tool mounting portion 24 of common OMT blades and accessories 22.

The embodiment(s) described above and illustrated in the figures are presented by way of example only and are not intended as a limitation upon the concepts and principles of the present disclosure. As such, it will be appreciated that variations and modifications to the elements and their configuration and/or arrangement exist within the spirit and scope of one or more independent aspects as described.

Various features and advantages of the invention are set forth in the following claims.

What is claimed is:

1. A container comprising:
a base including base walls and a cavity defined by the base walls;
a receptacle on one of the base walls; and
a retainer selectively coupled to the receptacle and configured to support a plurality of tools within the cavity, the base being sized to receive only a single retainer.

2. The container of claim 1, wherein the retainer is selectively coupled to the receptacle by a snap-fit connection.

3. The container of claim 2, wherein the receptacle includes one or more apertures extending from the cavity to an outer surface of the base, and wherein the retainer includes one or more tabs extending through the one or more apertures.

4. The container of claim 3, wherein the base includes a pocket formed on the outer surface, and wherein portions of the one or more tabs are received in the pocket.

5. The container of claim 3, further comprising a locating feature on the one of the base walls to engage the retainer.

6. The container of claim 5, wherein the locating feature includes a boss located on an inner surface of the base and at partially surrounding the one or more apertures, and wherein the retainer includes one or more legs positioned radially outward of the one or more tabs and surrounding the boss.

7. The container of claim 5, wherein the one or more apertures include two apertures and the one or more tabs includes two tabs, wherein the locating feature includes a bridge separating the two apertures, and wherein the retainer includes a stand positioned between the two tabs and engaging the bridge.

8. The container of claim 1, further comprising a lid movably coupled to the base to selectively enclose the cavity.

9. The container of claim 8, wherein the retainer includes a top portion that contacts the lid when the lid is in a closed position.

10. The container of claim 9, wherein the lid includes a pocket shaped to receive the top portion.

11. The container of claim 1, wherein the retainer includes a base portion, an insert portion extending from the base portion in a first direction, and a main body portion extending from the base portion in a second direction that is opposite the first direction, wherein the insert portion is releasably coupled to the receptacle, and wherein the main body portion is configured to receive the plurality of tools.

12. The container of claim 1, wherein the retainer is configured to support up to ten oscillating multi tool blades.

13. A container comprising:
a base including base walls and a cavity defined by the base walls;
a receptacle on one of the base walls; and
a retainer selectively received by the receptacle via a snap-fit connection and configured to support a stack of oscillating multi tool blades.

14. The container of claim 13, wherein the receptacle includes two apertures extending from the cavity to an outer surface of the base, and wherein the retainer includes two opposing and outwardly biased tabs extending through the two apertures.

15. The container of claim 13, further comprising a locating feature on the one of the base walls to engage the retainer.

16. The container of claim 15, wherein the locating feature includes a boss located on an inner surface of the base and at least partially surrounding the two apertures, and wherein the retainer includes two legs positioned radially outward of the two tabs and surrounding the boss.

17. The container of claim 15, wherein the locating feature includes a bridge separating the two apertures, and wherein the retainer includes a stand positioned between the two tabs and engaging the bridge.

18. A retainer configured to be secured within a container, the retainer comprising:
a base portion;
an elongated body extending from the base portion and configured to receive a stack of oscillating multi tool blades; and
an insert portion extending from the base portion and including a plurality of tabs, the plurality of tabs configured to extend through a wall of the container and form a snap-fit connection with the retainer, each tab having a stop extending normally from an end of the tab, the stops configured to bear against an outer surface of the wall of the container.

19. The retainer of claim 18, further comprising a set of legs positioned radially outwardly of the plurality of tabs and configured to bear against an inner surface of the wall of the container.

20. The retainer of claim 18, further comprising a stand positioned between the plurality of tabs and configured to bear against a portion of the container.
